(19) United States
(12) Patent Application Publication
(10) Pub. No.: US 2006/0266216 A1
(43) Pub. Date: Nov. 30, 2006

(54) High-throughput powder synthesis system

(75) Inventor: David E. Dericotte, Albuquerque, NM (US)

Correspondence Address: Mr. Jaimes Sher;Cabot Superior MicroPowders, 5401 Venice Avenue NE, Albuquerque, NM, 87113, US

(73) Assignee: Cabot Corporation

(21) Appl. No.: 11/136,277

(22) Filed: May 24, 2005

(51) Int. Cl. B01D 46/00

(52) U.S. Cl. 95/273

(57) ABSTRACT

The powder synthesis system integrates “on-the-fly” precursor formulation and delivery, control of carrier gas flow rate and temperatures of a multi-zone reactor (to control time-temperature history of the particles in the reactor), with rapid filtering/collection equipment into a powder synthesis process that is representative of actual manufacturing time-temperature conditions. A control system provides automatic operation and data acquisition, while requiring minimal operator involvement. The system includes a delivery stage, a production stage, and a collection stage. The collection stage uses a camera style filter apparatus to collect the powder with minimal loss and isolates each sample to prevent contamination.

### STATEMENT REGARDING FEDERALLY SPONSORED RESEARCH OR DEVELOPMENT

This invention was developed under U.S. Department of Energy (DOE) funding, Project #AL67620 “Development of High-Performance, Low-Pt Cathodes Containing New Catalysts and Layer Structure.”

### BACKGROUND OF THE INVENTION

1. Field of the Invention

This invention relates to the generation of particulates, especially powders, and also to systems in which such generated particulates are collected for testing. Such systems can be used in the development of electrocatalyst powders.

2. Discussion of Related Art

When developing new materials, it can be desirable to generate large numbers of samples with variable composition and microstructure for testing purposes. This allows developers to change compositions in an effort to design a material for a particular use. Accordingly, methods for fabricating and analyzing particulates with varying material properties to determine particulates having the best properties for a particular application are known.

For example, U.S. Patent Publication 2002/0184969 to Kodas et al. discloses a process of continuously providing various precursor compositions, each formed by selecting certain individually stored materials. Each composition is mixed, formed into an aerosol, and transported to a processor in a carrier gas. The droplets are processed into particles, and the particles are collected in a controlled manner by spraying them onto a long filter substrate that can be rolled. The substrate can include trenches or wells in which the particles are collected and then sealed with a substrate cap.

Additionally, U.S. Pat. No. 6,832,735 to Yadav et al. discloses methods for real time quality control of nanoscale and fine powder manufacture in which a precursor is made and then processed to obtain a powder. The gaseous products from the process can be monitored for composition, temperature, and other variables to ensure quality. After the powder is formed, it is quenched according to various methods, preferably methods that can prevent the deposition of powders on the conveying walls in the system. These methods can include blanketing the powder with gases. The powder is then collected by any method, including membrane filtration. A related patent by Yadav, U.S. Pat. No. 6,719,821, discusses the production and selection of precursor mixtures to produce fine powders.

Another patent that uses means to prevent powders from accumulating on the walls in a system is U.S. Pat. No. 4,994,107 to Flagan et al. In Flagan, submicron particles are produced, and the aerosolized product is collected on Teflon membrane filters. To prevent thermophoretic deposition of the small particles in the hot reactant flow on the cool walls of the sampling system, the aerosol is diluted by blowing cool, room temperature nitrogen through the walls of the diluter prior to collection of the particles.

U.S. Pat. No. 4,556,416 to Kamijo et al. relates to a process and apparatus for manufacturing a fine powder in which a carrier gas with particles is introduced into a reaction chamber and ions are mixed with the gas while exciting/heating the gas and particles with laser beams. The carrier gas and powder are discharged and collected with a filter.

There is a need in sampling systems to obtain consistent and accurate results so that the generation of the material or additional testing can be precisely reproduced and provide useful data for accountability of the testing. The challenges in such systems include precursor preparation, since the properties of the ultimate material are dependent on the composition and processing conditions, and material sample collection, since particulate loss and cross-contamination will provide unreliable results. There is also a need to be able to prepare the samples and collect the samples in a high throughput manner to reduce costs and development time.

### BRIEF SUMMARY OF THE INVENTION

Aspects of embodiments of the invention relate to a system that allows “on-the-fly” precursor formulation and delivery.

Another aspect of embodiments of the invention relates to a system that provides safe and pure collection of samples.

An additional aspect of embodiments of the invention relates to a system in which certain parameters are controlled and are representative of actual manufacturing conditions.

A further aspect of embodiments of the invention relates to providing a system that is automatic and functions with integrated components.

This invention is directed to a collector for a powder synthesis system comprising a filter assembly including a feed zone, a collection zone, and a storage zone, and an elongated porous filter extending from the feed zone to the storage zone through the collection zone along a feed path. The filter has a surface that is exposed when positioned in the collection zone. A driver is connected to the filter assembly that indexes the filter to positions along the feed path to progressively expose different areas of the surface of the filter in the collection zone for powder collection and advance the exposed areas of the surface of the filter toward the storage zone. A film supply adjacent the storage zone applies film to the surface of the filter in the storage zone to cover the previously exposed areas of the surface of the filter for retaining collected powder. An inert gas source in communication with the feed zone and the storage zone provides a continuous flow of inert gas from the feed zone toward the collection zone and from the storage zone toward the collection zone thereby creating a barrier around the collection zone and an oxygen free environment around at least the storage zone.

A controller can be connected to the filter assembly and the driver to control the positioning of the filter. A compound supplier can supply powder in a stream of carrier gas, wherein the collection zone is exposed to the stream of carrier gas so that the powder is collected on the exposed surface of the filter.

The invention is also directed to a method of collecting samples in a powder synthesis system having a filter assembly with a feed zone, a collection zone and a storage zone. The method comprises providing a flow of powder carried in a carrier gas, providing an elongated porous filter that extends from the feed zone through the collection zone and to the storage zone, and exposing a portion of the filter to the flow of powder carried in the carrier gas in the collection zone to separate the powder from the carrier gas and accumulate powder on a surface of the exposed portion of the filter. The method includes delivering a continuous flow of inert gas to the feed zone and the storage zone to create a barrier that inhibits powder from leaving the filter in the collection zone. The filter assembly is then actuated to advance the exposed portion of the filter toward the storage zone and position an unexposed portion of the filter in the collection zone. A film is applied over the exposed portion of the filter in the storage zone to cover the accumulated powder. The exposed portions of the filter from the storage zone are removed for analysis.

The invention is additionally directed to a method of synthesizing a high throughput of powder, comprising providing an accessible database of operating conditions, including physical data relating to precursor solutions, precursor feed rates, elemental composition of target materials, processing temperatures, carrier gas flow rates, filter specifications, and other system parameters. Variable control values are calculated based on the operating conditions. A precursor formulation is determined by selecting from individually stored chemical components, controlled amounts of the selected chemical components are mixed according to the calculated control values, the mixture is atomized into droplets, and the droplets are entrained in a carrier gas. The aerosol droplets are processed by heating at a calculated processing temperature and converting the droplets into a fine powder entrained in the carrier gas. The carrier gas and powder are cooled to a calculated cooled temperature. Then, the carrier gas and powder are caused to flow past a porous filter at a calculated rate to separate the powder from the carrier gas. The powder is collected and stored on a surface of the porous filter. The variable system parameters are automatically monitored and controlled, and data representative of actual operating conditions is automatically collected.

The method can include delivering a continuous flow of inert gas toward the collection zone during collection of the powder to inhibit powder from leaving the collection zone. The method can also include applying a film to cover the surface of the porous filter after the powder is collected and prior to storage.

These and other aspects of the invention will become apparent when taken in conjunction with the detailed description and appended drawings.

### BRIEF DESCRIPTION OF THE DRAWINGS

The invention will now be described in conjunction with the accompanying drawings in which:

FIG. 1 is a schematic diagram of the high throughput system in accordance with an embodiment of the invention;

FIG. 2 is a block diagram of the system steps in accordance with the system of the invention;

FIG. 3 is front schematic view of the collector in accordance with the invention;

FIG. 4 is side perspective view of the storage unit of the collector of FIG. 3; and

FIG. 5 is a partial side view of the collection zone of the collector of FIG. 3.

In the drawings, like reference numerals indicate corresponding parts in the different figures.

### DETAILED DESCRIPTION OF PREFERRED EMBODIMENTS

This invention is directed to a powder synthesis system capable of generating large numbers of electrocatalyst powders with variable composition and microstructure. However, the system described herein and the components usable in this system are not limited to a high throughput system or to a generation of electrocatalyst powders. Any type of particulate could be generated and collected in this system.

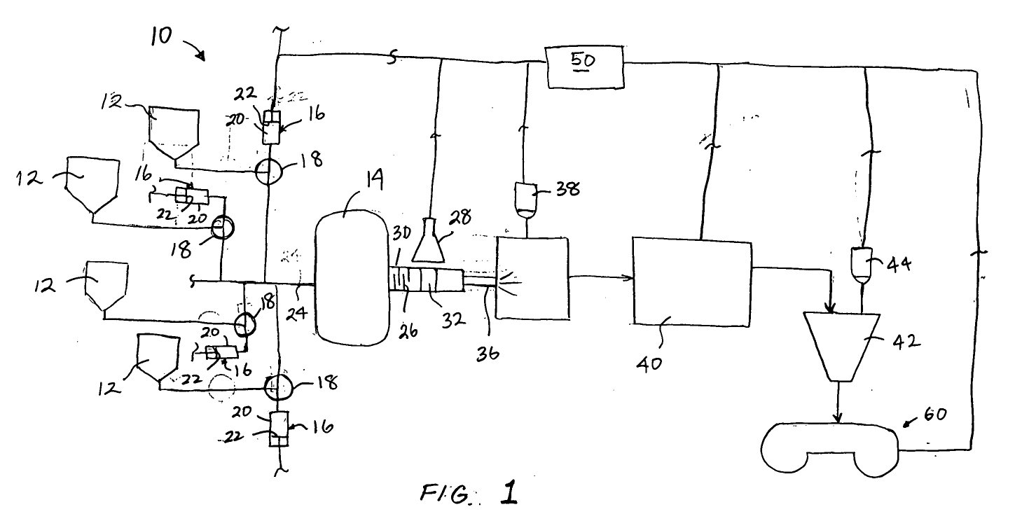

Referring to FIG. 1, a system 10 in accordance with one embodiment of this invention is shown schematically. The system 10 and its components are controlled by a controller 50, which is described below after the description of the components within the system. The system 10 includes a plurality of reservoirs 12 in which individual chemical components are stored in separate solutions. Any number of reservoirs 12 can be used depending on the desired combinations of chemical components. For example, four different reservoirs for metal components and two different reservoirs for carbon components could be provided to allow for a wide variety of compositions while requiring minimal downtime for cleaning or reconfiguration.

The reservoirs 12 are connected to a manifold 14 for mixing the selected components into a solution. The components are selected from a reservoir 12 and injected into the manifold 14 by computer controlled syringes 16 using a coordinated syringe and valve system. The syringes 16 are each connected a three way valve 18 that directs the path of the syringe 16 to the reservoir 12 (for filling) or to the manifold 14 (for mixing). All of the syringe lines meet and mix at the manifold 14. The syringes 16 may be operated independently or simultaneously. When operated simultaneously in the dispense mode, mixing also occurs in the manifold exhaust port 24 leading to the main chamber of the manifold 14.

Each syringe 16 has a barrel 20 mounted on a stationary sled and a plunger 22 mounted on a movable sled that controls the motion of the plunger 22. The delivered volume of the chemical is a function of the diameter of the barrel 20 and the distance the plunger 22 moves. The rate of delivery of the chemical is controlled by the speed of the plunger 22. Of course, any type of controlled injection assembly could be used in this system to provide a controlled quantity of chemicals to a mixer.

In the manifold 14, mixing of the chemical components will occur from diffusion. It may be desirable with chemicals having higher viscosities (greater than 1 cP) and low Reynolds numbers to further enhance mixing with additional mixing mechanisms. For example, a static in-line mixer 26 may be provided at a point downstream of the manifold 14. Alternatively or in addition to the in-line mixer 26, a non-contact ultrasonic mixer 28 can be provided to enhance radial mixing in the tubing 30 leading from the manifold 14. In this case, a segment of the tubing 30 is replaced with glass tubing 32 and an ultrasonic horn 28 is placed in close proximity to the glass tubing 32. Glass is preferred since it transmits the ultrasonic energy more effectively than flexible tubing. Mixing should be enhanced in this arrangement because biological cells can be disrupted. As would be recognized by those of ordinary skill in the art, any type of mixing apparatus maybe added or replaced to achieve an effectively mixed solution, especially if the system is designed for particular precursor compositions.

After mixing, the solution is transported to an ultrasonic nozzle 34. The solution is atomized into droplets by the nozzle 34 and entrained in a carrier gas supplied from a gas source 36. Preferably, the droplets are atomized into about 10 micron size droplets. Again, based on the desired application of this system, it may be preferable to atomize the droplets into a different size or to use another method of atomization. The droplets and gas are then transported to the production stage. The initial chemical supply point at the reservoirs 12 along with the mixing and atomization stages form the delivery stage of the assembly as these components supply the compound for processing.

At the production stage, the composition is treated to form a particulate, in this case a powder. The droplets and carrier gas are delivered to a reactor 40, where the aerosol droplets are heated to remove solvent. The droplets are converted to a finely divided powder generally by a chemical reaction between the aerosol components, as is known. The reactor 40 can be a single zone or multi-zone reactor for temperature profiling, if desired. The powder, entrained in the carrier gas, is then transported to the collection stage.

At the collection stage, the powder and carrier gas are cooled in a cooler 42 with a quench gas supplied from a quench gas supply 44 to reduce the temperature of the processed particles and the carrier gas to a predetermined temperature, such as less than 150° C. The particles are then separated from the carrier gas in a filter assembly 60, described in detail below.

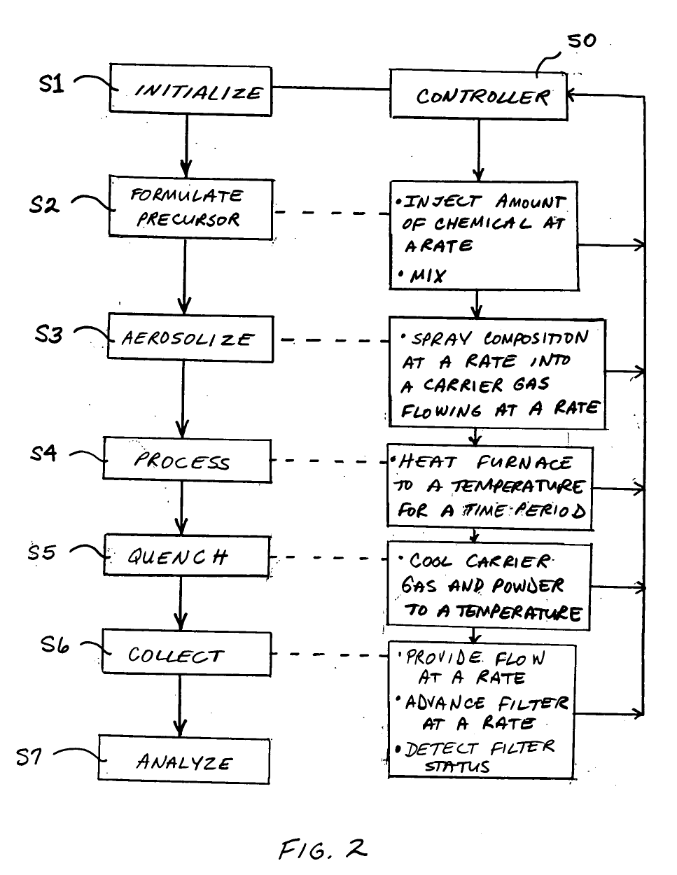

Referring back to the controller 50, FIG. 2 is a block diagram showing a control process suitable for use with the system 10 disclosed herein. The controller 50 may be any known type of microprocessor, including portions of various processing systems working in tandem. The controller 50 can be implemented in any known way, including by way of connection to a main frame computer, a personal computer, a network, or on machine readable medium. The controller 50 is shown symbolically connected to various components of the system 10 in FIG. 1, which is only intended to represent some of the communication lines within the system. It will be understood by those of ordinary skill in the art that these connections are symbolic only and will comprise any type of connection including hard wire and wireless and will communicate with various components in the system, not necessarily shown directly connected in FIG. 1. The controller 50 can also communicate with other control platforms to integrate operations and transmit data and instructions.

The controller 50 is provided with, or has access to, a database of operating conditions, including the physical data of the initial precursor chemical solutions and the critical operating parameters. Such parameters would be known to those of ordinary skill in the art and include processing temperatures, gas flow rates, precursor feed rates, and elemental compositions of the target materials. These values can be provided in a look up table, spreadsheet form, or any other known data storage configuration.

The controller 50 converts the established operating parameters into control values for variables, such as carrier gas flow rates, precursor mixing ratios and delivery rates, furnace temperatures, filter position, and filter drive rates. These values are established and then maintained and monitored by the controller 50. The controller 50 also performs critical parallel functions to collect data for reference and quality control, ensure sample isolation, and maintain safe operating conditions. Accordingly, the controller 50 has the ability to present graphical, numerical, and statistical data for each run in real time charts and spreadsheets. The controller 50 also has the ability to automatically make corrections or shut down the system in case of deviations from the operating conditions.

FIG. 2 shows the principal steps in the system along the left column and various control actions involved in these steps that are actuated, controlled, monitored, and recorded by the controller in the right column. The individual feedstock precursor solutions stored in the reservoirs are supplied by an operator. From that point, the system 10 operates automatically through the controller 50.

After the system is initialized at step S1, the precursor composition is formulated at step S2. Formulation can be accomplished “on-the-fly” with the injection of certain of the chemicals to the manifold at a specified volume and rate. The syringes 16 can be actuated consecutively or simultaneously to formulate unique compositions at a rapid rate.

After the chemicals are supplied to the manifold 14, mixing can be controlled by controller 50 based on the selected chemicals or other factors. The mixed composition is then aerosolized at step S3 at a controlled rate to achieve certain size droplets and is provided to the reactor 40 in the production stage in a determined amount and at a determined rate.

The production stage is closely controlled so that the composition is processed at step S4 in a manner that would be representative of actual manufacturing time and temperature conditions. Accordingly, an important function of the controller 50 is to monitor and record the time-temperature history of the particles in the reactor 40 by controlling the carrier gas flow rate and the temperature of the reactor 40.

After processing, the particles and carrier gas is quenched at step S5 to a predetermined temperature. The cooled particles are then collected at step S6, described below, and analyzed at step S7.

All of the steps are controlled by controller 50, which also receives feedback from various sensors for data collection and continual adjustments if necessary.

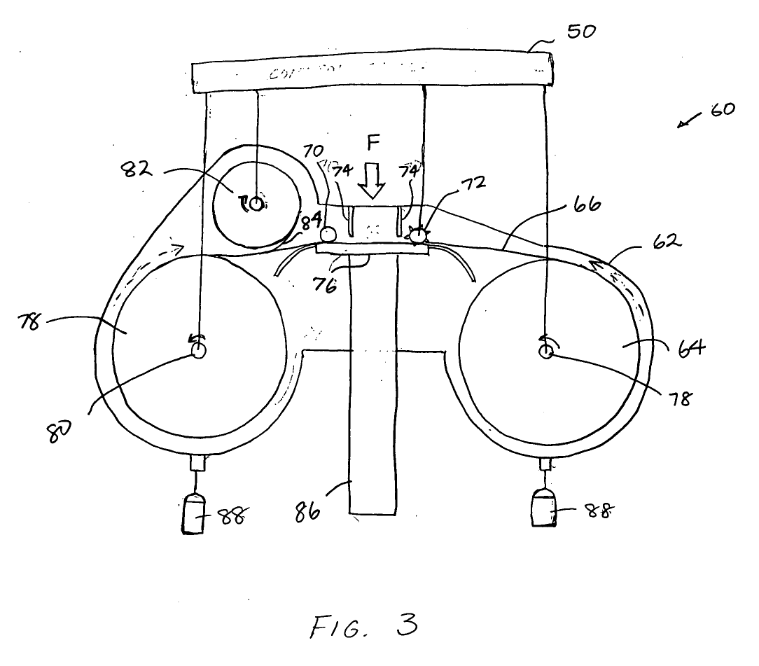

The collection stage involves separating the processed particles from the carrier gas in a filter assembly 60, seen in detail in FIG. 3. The filter assembly 60 is a camera-type filter assembly including a supply zone, a collection zone and a storage zone contained in a housing 62. The supply zone has a supply spool 64 that supports a web of elongated porous filter material 66. The supply spool 64 is carried on a spindle 68 for rotation to dispense unexposed filter material toward the collection zone. The spindle 68 is connected to a clutch to maintain tension in the filter material 66.

A drive assembly is connected to the controller 50 and includes the spindle 68, nip rolls 70 and/or sprockets 72, and a drive shaft 80. The drive assembly advances the filter material 66 through the collection zone. The controller 50 can advance the material to predetermined discrete indexed locations or can advance the filter material 66 in a continuous manner, either at a constant speed or a variable speed. The movement and condition of the web are preferably monitored to ensure that there is continuity in the web throughout the assembly.

Seen in detail in FIG. 5, the collection zone is formed of a narrow feed passage defined by baffles 74, which define a flow path F for the carrier gas and particles, and a porous support grid 76. The grid 76, along with the drive assembly, keeps the filter material 66 flat and relatively rigid to ensure that the entire volume of carrier gas passes through the filter material 66. The carrier gas and entrained particles flow through collection zone in flow path F and the particles P, in this case powder, collects on the filter material 66 while the carrier gas flows through the grid 76 and exits the filter assembly 60 through exit passage 86.

After the particles P accumulate on the filter material 66, the web is advanced to the storage zone toward storage spool 78, which is carried on drive shaft 80. Positioned adjacent to the storage spool 78 after the collection zone is a film supply 82 that is a roll of film 84, for example a polyimide film such as Dupont Kapton® film, that is dispensed over the exposed filter material 66 to cover the collected particle samples. Preferably, the supply roll 82 is clutched to maintain a taut supply of film 84. The film 84 covers each sample prior to the filter material 66 being wound onto the storage spool 78. By this, cross contamination between layers of material 66 can be prevented and loss of the powder P can be eliminated while the spool 78 is being rolled. Each of the spools 64, 78, and 82 has an encoder and is connected to the controller 50 to control the feed and provide data.

Another feature of the filter apparatus 60 is the provision of an inert gas flow from an inert gas source 88, such as nitrogen. Preferably, the inert gas is continuously provided to the feed and storage zones during collection. As a result, the storage spool 78 is blanketed in an oxygen free environment, which reduces the possibility of combustion of the particulate P. The inert gas flows from the far ends of the feed and storage zones toward the collection zone as can be appreciated by the dashed arrows shown in FIG. 3. Since the collection zone has a narrow feed passage between baffles 74 and grid 76 that is only slightly larger than the thickness of the filter material 66, a barrier is created by the inert gas around the collection zone that inhibits the flow of particles P from the collection zone into the feed and storage zones. This minimizes cross contamination and maximizes collection efficiency.

In one manner of operation, the filter material 66 is advanced to predetermined positions in the collection zone for each sample run. In another operation, the filter material 66 is moved at a predetermined velocity, either constant or variable, while the precursor formulation is varied in a time-dependent manner by varying the relative rates of component delivery in the syringes 16 as a function of time to create a continuous deposit of particles P whose composition varies as a function of the position on the web. The compositions can then be determined by calculating the position relative to the speed and time or determined based on fiduciary marks made on the web during the run.

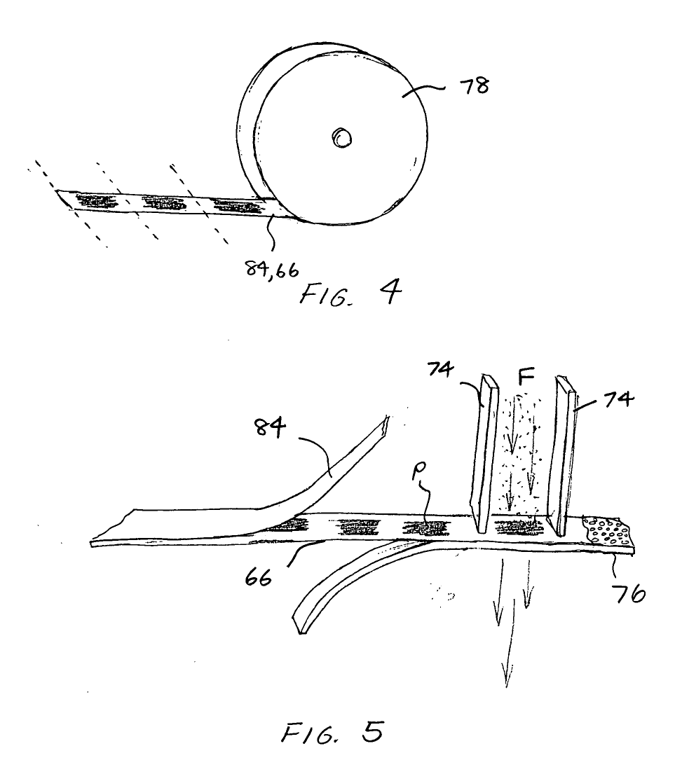

After a series of runs are completed, the exposed filter material 66 covered with the film 84 is removed from the storage spool 78 and each powder sample P is collected for evaluation and testing, as seen in FIG. 4. Each sample can be individually packaged for characterization, storage or shipment. The number of samples that can be produced in any given period is determined by the precursor formulation rate and the sample size required for analysis. In one assembly, the production of 100-300 samples is anticipated per week.

As can be appreciated from the above description, this process requires minimal operator involvement due to the automatic actuation and monitoring of the steps, which ensures consistent and accurate results. The system also provides for automatic data collection, which ensures reproducibility and accountability.

Thus, this system can perform a series of experiments around multiple components (six, for example) to identify a combination of components that optimize a desired property, such as catalytic efficiency.

Various modifications can be made in the invention as described herein, and many different embodiments of the device and method can be made while remaining within the spirit and scope of the invention as defined in the claims without departing from such spirit and scope. It is intended that all matter contained in the accompanying specification shall be interpreted as illustrative only and not in a limiting sense.

What is claimed is:

1. A collector for a powder synthesis system, comprising:
a filter assembly including a feed zone, a collection zone, and a storage zone, and an elongated porous filter extending from the feed zone to the storage zone through the collection zone along a feed path, wherein the filter has a surface that is exposed when positioned in the collection zone;
a driver connected to the filter assembly that indexes the filter to positions along the feed path to progressively expose different areas of the surface of the filter in the collection zone for powder collection and advance the exposed areas of the surface of the filter toward the storage zone;
a film supply adjacent the storage zone that applies film to the surface of the filter in the storage zone to cover the previously exposed areas of the surface of the filter for retaining collected powder; and
an inert gas source in communication with the feed zone and the storage zone that provides a continuous flow of inert gas from the feed zone toward the collection zone and from the storage zone toward the collection zone thereby creating a barrier around the collection zone and an oxygen free environment around at least the storage zone.

2. The collector of claim 1, further comprising a controller connected to the filter assembly and the driver to control the positioning of the filter.

3. The collector of claim 2, wherein the controller drives the filter to predetermined discrete positions along the feed path for powder collection.

4. The collector of claim 2, wherein the controller drives the filter in a continuous manner for powder collection.

5. The collector of claim 1, further comprising a compound supplier that supplies powder in a stream of carrier gas, wherein the collection zone is exposed to the stream of carrier gas so that the powder is collected on the exposed surface of the filter.

6. The collector of claim 5, wherein the compound supplier includes an injection assembly and a manifold, wherein a combination of compounds are selected and individually injected into the manifold for mixing.

7. The collector of claim 6, wherein the injection assembly includes a coordinated syringe and valve system.

8. The collector of claim 6, wherein the compound supplier further includes a mixer downstream of the manifold.

9. The collector of claim 8, wherein the mixer is an in-line mixer.

10. The collector of claim 8, wherein the mixer is a non-contact ultrasonic mixer.

11. The collector of claim 1, wherein the film applied to the surface of the filter is a polyimide film.

12. The collector of claim 1, wherein the inert gas includes nitrogen.

13. The collector of claim 1, wherein the feed zone comprises a spool of unexposed filter, the storage zone comprises a spool of exposed filter, and the feed path includes a porous grid that supports the filter during exposure.

14. A method of collecting samples in a powder synthesis system having a filter assembly with a feed zone, a collection zone and a storage zone, the method comprising:
providing a flow of powder carried in a carrier gas;
providing an elongated porous filter that extends from the feed zone through the collection zone and to the storage zone;
exposing a portion of the filter to the flow of powder carried in the carrier gas in the collection zone to separate the powder from the carrier gas and accumulate powder on a surface of the exposed portion of the filter;
delivering a continuous flow of inert gas to the feed zone and the storage zone to create a barrier that inhibits powder from leaving the collection zone;
actuating the filter assembly to advance the exposed portion of the filter toward the storage zone and position an unexposed portion of the filter in the collection zone;
applying a film to cover the exposed portion of the filter and the accumulated powder in the storage zone; and
removing the exposed portions of the filter from the storage zone for analysis.

15. The method of claim 14, wherein delivering a continuous flow of inert gas to the storage zone further comprises creating an oxygen free environment around the storage zone.

16. The method of claim 14, wherein actuating the filter assembly includes advancing the exposed portion of the filter to discrete locations in the collection zone.

17. The method of claim 14, wherein actuating the filter assembly includes advancing the exposed portion of the filter in a continuous manner so that powder accumulates along an extended length of the filter.

18. The method of claim 14, further comprising maintaining the filter in a taut condition in the collection zone.

19. A method of synthesizing a high throughput of powder, comprising:
providing an accessible database of operating conditions, including physical data relating to precursor solutions, precursor feed rates, elemental composition of target materials, processing temperatures, carrier gas flow rates, filter specifications, and other system parameters;
calculating variable control values based on the operating conditions;
determining a precursor formulation by selecting from individually stored chemical components;
mixing controlled amounts of the selected chemical components according to the calculated control values;
atomizing the mixture into droplets and entraining the droplets in a carrier gas;
processing the aerosol droplets by heating at a calculated processing temperature and converting the droplets into a fine powder entrained in the carrier gas;
cooling the carrier gas and powder to a calculated cooled temperature;
causing the carrier gas and powder to flow past a porous filter at a calculated rate to separate the powder from the carrier gas;
collecting and storing the powder on a surface of the porous filter; and
automatically monitoring and controlling the variable system parameters and automatically collecting data representative of actual operating conditions.

20. The method of claim 19, further comprising delivering a continuous flow of inert gas toward the collection zone during collection of the powder to inhibit powder from leaving the filter in the collection zone.

21. The method of claim 19, further comprising applying a film to cover the surface of the porous filter after the powder is collected and prior to storage.

22. The method of claim 19, further comprising receiving a signal representative of a condition of the filter to detect discontinuities in the filter.

23. The method of claim 19, wherein mixing controlled amounts of the selected chemical components includes varying the composition in a time dependent manner.

24. The method of claim 19, wherein collecting and storing the powder includes advancing the porous filter each time a different precursor is formulated so that individual powder samples are collected for each precursor formulation.

25. The method of claim 24, further comprising determining the location of a particular powder deposited on the filter based on time dependent mixing of the selected chemical components.
